(19) United States
(12) Patent Application Publication
(10) Pub. No.: US 2018/0240095 A1
(43) Pub. Date: Aug. 23, 2018

(54) PROCESSING SELF-CHECKOUT TRANSACTION USING PORTABLE DEVICE LINKED TO MOBILE DEVICE

(71) Applicant: Wal-Mart Stores, Inc., Bentonville, AR (US)

(72) Inventors: Paul Buckley, Rogers, AR (US); Douglas E. Humphrys, Bentonville, AR (US)

(21) Appl. No.: 15/881,897

(22) Filed: Jan. 29, 2018

Related U.S. Application Data
(60) Provisional application No. 62/462,652, filed on Feb. 23, 2017.

(51) Int. Cl. G06Q 20/32; G06Q 30/06

(52) U.S. Cl. CPC G06Q 20/322; G06K 7/1417; G06Q 20/3274; G06Q 30/0601

(57) ABSTRACT

A method for processing a transaction at a checkout location, is provided, including the steps of generating a unique identifier associated with the transaction to be displayed on a display of a checkout computing device at the self-checkout location, in response to a payment method selection by a user, receiving a request from a mobile device of the user to complete the transaction, in response to the mobile device receiving transaction details from a portable device, the portable device retrieving the transaction details associated with the transaction by capturing the unique identifier displayed on the display of the checkout computing device, wherein the portable device is wirelessly linked to the mobile device, and processing the request from the mobile device to complete the transaction, wherein the transaction is completed without the user interacting with the mobile device. An associated computer system, computer program product, and portable device is also provided.

### CROSS REFERENCE TO RELATED APPLICATION[S]

This application claims the benefit of U.S. Provisional application No. 62/462,652, filed Feb. 23, 2017, the contents of which are incorporated herein in their entirety.

### TECHNICAL FIELD

The following relates to systems and methods for processing transactions at a self-checkout device, and more specifically to embodiments of a method for processing transactions using a portable device linked to a mobile device.

### BACKGROUND

After merchandise is scanned at a self-checkout lane, the self-checkout computing device prompts the customer to select a payment method for the scanned merchandise. Payment methods have been expanded to include mobile application payment, wherein the customer pays for the scanned merchandise using a software application on the customer's mobile device. Typically, the mobile device must be manipulated by the customer in some way to facilitate the mobile payment. For example, the user must hold the mobile device proximate the self-checkout computing device, and then interact with the mobile device by pressing buttons, opening applications, and/or operating a camera. Interacting with the mobile device to facilitate the mobile payment increases the customer's time spent in the self-checkout lane, and in some cases, causes confusion if the exact process is not followed by the customer. Further, the customer must often times retrieve the mobile device from the customer's purse or pocket, exposing the mobile device to a risk of being dropped.

Thus, a need exists for a system for automatically processing a self-checkout transaction using a portable device linked to the customer's mobile device.

### SUMMARY

A first aspect relates to a method, and associated computer system and computer program product, and portable device for processing a checkout transaction.

A second aspect relates to a method for processing a transaction at a checkout location, the method comprising: generating, by a processor of a computing system, a unique identifier associated with the transaction to be displayed on a display of a checkout computing device at the checkout location, in response to a payment method selection by a user, receiving, a request from a mobile device of the user to complete the transaction, in response to the mobile device receiving transaction details from a portable device, the portable device retrieving the transaction details associated with the transaction by capturing the unique identifier displayed on the display of the checkout computing device, wherein the portable device is wirelessly linked to the mobile device, and processing, by the processor, the request from the mobile device to complete the transaction, wherein the transaction is completed without the user interacting with the mobile device.

A third aspect relates to a computer system, comprising: a processor, a memory device coupled to the processor, and a computer readable storage device coupled to the processor, wherein the storage device contains program code executable by the processor via the memory device to implement a method for processing a transaction at a checkout location, the method comprising: generating, by a processor of a computing system, a unique identifier associated with the transaction to be displayed on a display of a checkout computing device at the checkout location, in response to a payment method selection by a user, receiving, a request from a mobile device of the user to complete the transaction, in response to the mobile device receiving transaction details from a portable device, the portable device retrieving the transaction details associated with the transaction by capturing the unique identifier displayed on the display of the checkout computing device, wherein the portable device is wirelessly linked to the mobile device, and processing, by the processor, the request from the mobile device to complete the transaction, wherein the transaction is completed without the user interacting with the mobile device.

A fourth aspect relates to a computer program product, comprising a computer readable hardware storage device storing a computer readable program code, the computer readable program code comprising an algorithm that when executed by a computer processor of a computing system implements a method for processing a transaction at a checkout location, comprising: generating, by a processor of a computing system, a unique identifier associated with the transaction to be displayed on a display of a checkout computing device at the checkout location, in response to a payment method selection by a user, receiving, a request from a mobile device of the user to complete the transaction, in response to the mobile device receiving transaction details from a portable device, the portable device retrieving the transaction details associated with the transaction by capturing the unique identifier displayed on the display of the checkout computing device, wherein the portable device is wirelessly linked to the mobile device, and processing, by the processor, the request from the mobile device to complete the transaction, wherein the transaction is completed without the user interacting with the mobile device.

A fifth aspect relates to a portable device for automatically processing a transaction, the portable device for assisting an automatic mobile processing of a transaction, the portable device comprising: a plastic housing having a first end and a second end, a lens being provided at the first end, the housing enclosing: a specialized integrated circuit comprising: a charge-coupled device imaging sensor for capturing digital data associated with a unique identifier displayed on a display of a computer located at a checkout location; a wireless network interface for securely and exclusively linking with a user smartphone associated with a user, over a short range communication network; a laser based targeting device for emitting a laser beam outside the plastic housing through the lens; and an embedded processor; a power source for providing a power to the specialized integrated circuit; a switch for activating the power source, the switch being located at least partially external to the plastic housing; an attachment mechanism coupled to the second end of the plastic housing, the attachment mechanism being used to attach the portable device to an object; wherein the portable device cannot locally perform computations necessary to utilize the digital data to complete the transaction.

A sixth aspect relates to a method for automatically processing a transaction at a checkout location, the method comprising: generating, by a processor of a computing system, a unique identifier associated with the transaction to be displayed on a display of a checkout computing device at the checkout location, in response to a payment method selection inputted by a user at the checkout computing device to complete the transaction using a mobile payment software application loaded on a user smartphone; receiving, by the processor, a request from the user smartphone running the mobile payment software application to complete the transaction, wherein the request from the user smartphone is generated and sent without the user physically interacting with the user smartphone, the request being generated and sent in response to the user smartphone receiving digital data from a portable device that the user physically interacts with to retrieve the transaction details associated with the transaction, the portable device having a specialized integrated circuit that comprises a charge-coupled device for capturing digital data associated with the unique identifier displayed on the display of the checkout computing device, wherein the portable device is securely and wirelessly linked exclusively to the user smartphone via a wireless network interface of the specialized integrated circuit of the portable device to transmit the digital data to the user smartphone, further wherein the user smartphone automatically launches the mobile payment software in response to receiving the digital data from the portable device; and processing, by the processor, the request from the user smartphone to complete the transaction; wherein the portable device is used to capture the unique identifier so that the user can avoid interacting with the user smartphone from a beginning of the transaction through an end of the transaction.

A seventh aspect relates to a method for transmitting data to a user smartphone for processing a transaction at a checkout location, the method comprising: in response to an actuation of a switch located at least partially external to a housing of a portable imaging device, activating a power source of the portable device, the power source providing power to a specialized integrated circuit of the portable imaging device, the specialized integrated circuit comprising a charge-coupled device imaging sensor for capturing a unique identifier associated with the transaction that is displayed on a display of a checkout computing device at the checkout location, the unique identifier being generated in response to a payment method selection selected by a user at the checkout computing device to complete the transaction using a mobile payment software application loaded on the user smartphone; transmitting digital data associated with the unique identifier via a wireless network interface of the specialized integrated circuit of the portable imaging device to the user smartphone, and as a function of the transmitting the digital data to the user smartphone, the transaction is completed using the mobile payment software application loaded on the user smartphone, without user interaction with the user smartphone; and after transmitting the digital data to the user smartphone, deactivating the power source so that the power source no longer provides power to the specialized integrated circuit of the portable imaging device to reduce a power consumption of the portable imaging device.

An eight aspect relates to a method for automatically processing a transaction at a checkout location, the method comprising: receiving, by a user smartphone, digital data from a portable imaging device that a user physically interacts with to capture a unique identifier, the unique identifier being displayed on a display of a checkout computing device at the checkout location, and generated in response to a payment method selection inputted by the user at the checkout computing device to complete the transaction using a mobile payment software application loaded on the user smartphone, wherein the portable device is securely and wirelessly linked exclusively to the user smartphone to transmit the digital data to the user smartphone; launching, by the user smartphone, the mobile payment software application, in response to receiving the digital data from the portable imaging device, without a user interaction with the user smartphone; and generating, by the user smartphone, a request to complete the transaction, wherein the request from the user smartphone is generated and sent to a remote server without the user physically interacting with the user smartphone, wherein the remote server is configured to process the request from the user smartphone to complete the transaction.

### BRIEF DESCRIPTION OF THE DRAWINGS

FIG. 1 depicts a block diagram of a checkout processing system, in accordance with embodiments of the present invention.

FIG. 2 depicts a schematic view of a portable device scanning a unique identifier associated with a checkout transaction, in accordance with embodiments of the present invention.

FIG. 3 depicts a block diagram of a portable device, in accordance with embodiments of the present invention.

FIG. 4 depicts a first flow chart of a method for processing a transaction at a self-checkout location, in accordance with embodiments of the present invention.

FIG. 5 depicts a second flow chart of a method for processing a transaction at a self-checkout location, in accordance with embodiments of the present invention.

FIG. 6 depicts a third flow chart of a method for processing a transaction at a self-checkout location, in accordance with embodiments of the present invention.

FIG. 7 depicts a flow chart of a step in the method for processing a transaction at a self-checkout location of FIG. 6, in accordance with embodiments of the present invention.

FIG. 8 illustrates a block diagram of a computer system for the checkout processing system of FIG. 1, capable of implementing methods for processing a transaction at a self-checkout location of FIGS. 4-7, in accordance with embodiments of the present invention.

### DETAILED DESCRIPTION

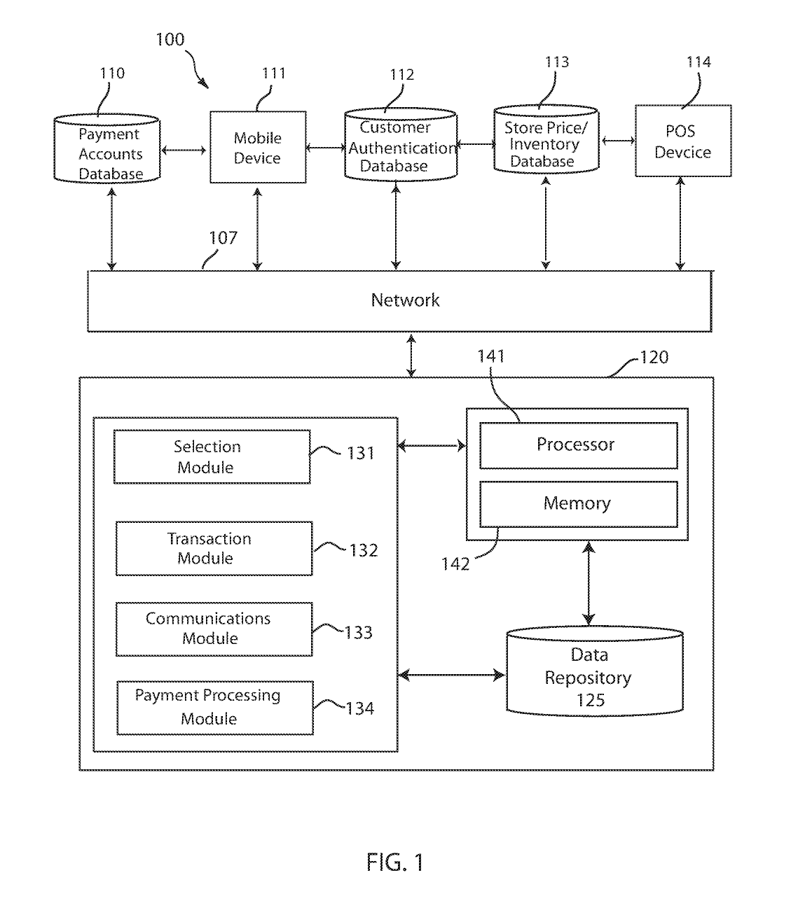

Referring to the drawings, FIG. 1 depicts a block diagram of a checkout processing system 100, in accordance with embodiments of the present invention. Embodiments of the checkout processing system 100 may run on one or more servers, servers systems, or other hardware devices, computing devices, and the like. The checkout processing system 100 may receive one or more communications from a mobile device 111 of a user, when the user scans a unique identifier associated with a transaction for scanned merchandise with a portable device 115. The portable device 115 transmits information to the mobile device 111, which in turn facilitates a mobile payment for the scanned merchandise. Further, the user of the mobile device 111 may be authenticated by communicating with a customer authentication database 112, and payment information may be received from the payment accounts database 110 to process a mobile payment for the scanned merchandise. The scanned merchandise may thus be purchased at the checkout location without the user needing to interact with the user's mobile device 111.

Embodiments of purchase processing system 100 may include a computing system 120 coupled to a network 107. Computing system 120 may be a computing device, one or more computing devices, a hardware device, a storage device, a server, one or more servers, a server system, and the like. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture. Embodiments of network 107 may be comprised of more than one network.

In some embodiments, the network 107 may further comprise, in addition to the computer system 120, a connection to one or more network accessible knowledge bases containing information of the user, network repositories or other systems connected to the network 107 that may be considered nodes of the network 107. In some embodiments, where the computing system 120 or network repositories allocate resources to be used by the other nodes of the network 107, the computer system 120 and network repository (not shown) may be referred to as servers.

The network repository may be a data collection area on the network 107 which may back up and save all the data transmitted back and forth between the nodes of the network 107. For example, the network repository 114 may be a data center saving and cataloging user transactions with a retailer, to generate both historical and predictive reports regarding a particular user. In some embodiments, a data collection center housing the network repository may include an analytic module capable of analyzing each piece of data being stored by the network repository. Further, the computer system 120 may be integrated with or as a part of the data collection center housing the network repository. In some alternative embodiments, the network repository may be a local repository (not shown) that is connected to the computer system 120.

Referring still to FIG. 1, embodiments of the computer system 120 may be equipped with a memory device 142 which may store the various user information, transactions, product information, mobile payment account information, and the like, and a processor 141 for implementing the tasks associated with the checkout processing system 100.

Furthermore, embodiments of computer system 120 may include a selection module 131, a transaction module 132, a communication module 133, and a payment processing module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the computing system 120 may include a selection module 131. Embodiments of the communications module 131 may include one or more components of hardware and/or software program code for detecting that a user has selected a mobile application payment method of payment, at a checkout location such as a point of sale (POS) device 114 or a location in the store where a user intends to scan a unique identifier located directly on a product packaging or the product itself. The POS device 114 may be a computing device, a computer, terminal, and the like, located or otherwise positioned at a checkout location for interfacing with the user to facilitate a checkout/payment of store merchandise. The POS device 114 may be coupled to a product or merchandise scanner for scanning the store product/merchandise sought to be purchased by the user. In an exemplary embodiment, the POS device 114 may be located at a self-checkout location for processing a self-checkout by the user; however, the POS device 114 may be located at a traditional cashier's checkout lane. Moreover, embodiments of the POS device 114 may prompt the user to select a payment method after the merchandise has been scanned. The payment methods may include traditional methods such as cash and credit card, but may also include a mobile payment option. The mobile payment option allows a user to use hardware and/or software of the user mobile device 111 to facilitate a payment for the scanned merchandise. Embodiments of the selection module 131 may either be alerted by the POS device 114 or may detect or determine that the mobile payment option has been selected by the user.

When the mobile payment option is selected by the user, embodiments of the transaction module 132 may generate a unique identifier associated with the transaction for the purchase of the scanned merchandise, scanned at the POS device 114. For instance, embodiments of the transaction module 132 may include one or more components of hardware and/or software program code for generating the unique identifier for display at the POS device 114. In an exemplary embodiment, the computing system 120 may generate a unique identifier associated with the transaction to be displayed on a display of a checkout computing device at the checkout location, in response to a payment method selection inputted by a user at the checkout computing device to complete the transaction using a mobile payment software application loaded on a user smartphone. Embodiments of the unique identifier may be at least one of a QR code, a bar code, a UPC code, or a computer readable matrix bar code. The unique identifier, which when captured by a digital device, such as a charge-coupled device, may contain/provide information/digital data pertaining transaction details for the purchase of the scanned merchandise. For example, the unique identifier may include information regarding a total amount of funds needed to complete the transaction, a subtotal amount, a sales tax information, a detailed listing of the merchandise, date/time information, store information, and the like. The transaction module 132 may query or otherwise access a store price/inventory database 113 and/or the POS device 114 to obtain transaction details. Furthermore, embodiments of the transaction module 132 of computing system 120 may transmit the generated unique identifier to the POS device 114, such that the unique identifier is displayed on a display of the POS device 114, for capturing by the portable device 115.

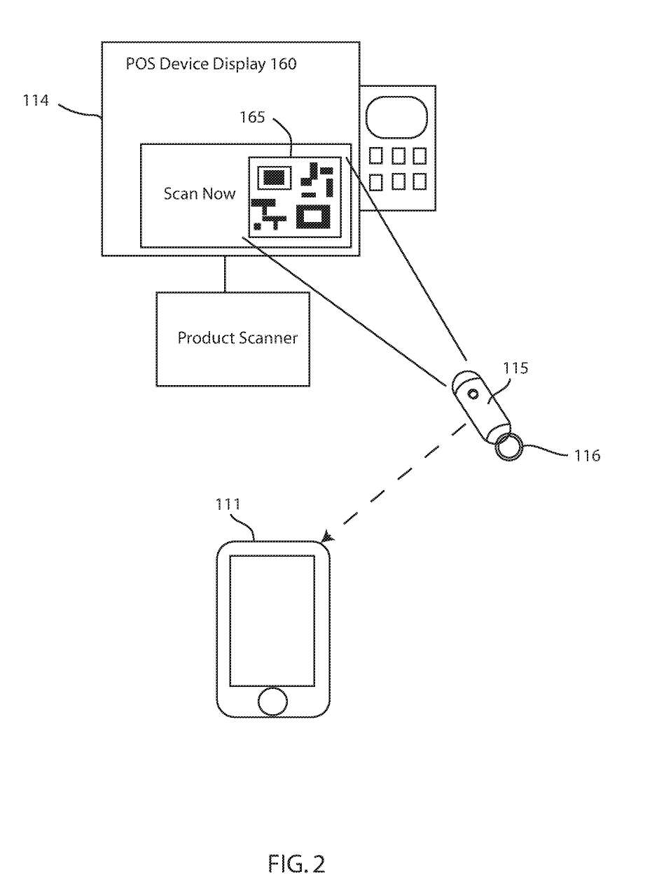

With continued reference to FIG. 1, and additional reference to FIG. 2, embodiments of the communications module 133 may include one or more components of hardware and/or software program code for receiving a communication from a mobile device 111, requesting that a payment be processed for merchandise scanned at a checkout location. Embodiments of the mobile device 111 may be a mobile device of a user located within a store or on a salesfloor of a retailer. The mobile device 111 may be a mobile computing device, a smartphone, a tablet, a cellular phone, or other internet connected mobile computing device. Embodiments of the mobile device 111 may request payment be processed in response to receiving information from portable device 115, wherein portable device 115 scans, captures, photographs, or otherwise obtained transactional details and information from the unique identifier, depicted as QR code 165, displayed on a POS device display 160 of the POS device, as shown in FIG. 2. Embodiments of the communications module 133 may receive a request from the user smartphone 111 running a mobile payment software application to complete the transaction, wherein the request from the user smartphone 111 is generated and sent without the user physically interacting with the user smartphone 111. The request can be generated and sent in response to the user smartphone 111 receiving digital data from a portable device 115 that the user physically interacts with to retrieve the transaction details associated with the transaction.

The portable device 115 may be communicatively coupled to the mobile device 111. In an exemplary embodiment, the portable device 115 is linked or paired with the mobile device 111 exclusively. For instance, embodiments of the portable device 115 may be exclusively linked, paired, or synced to the user's mobile device 111 to transmit information/data obtained from scanning the QR code 165 located on the display 160 at a checkout location.

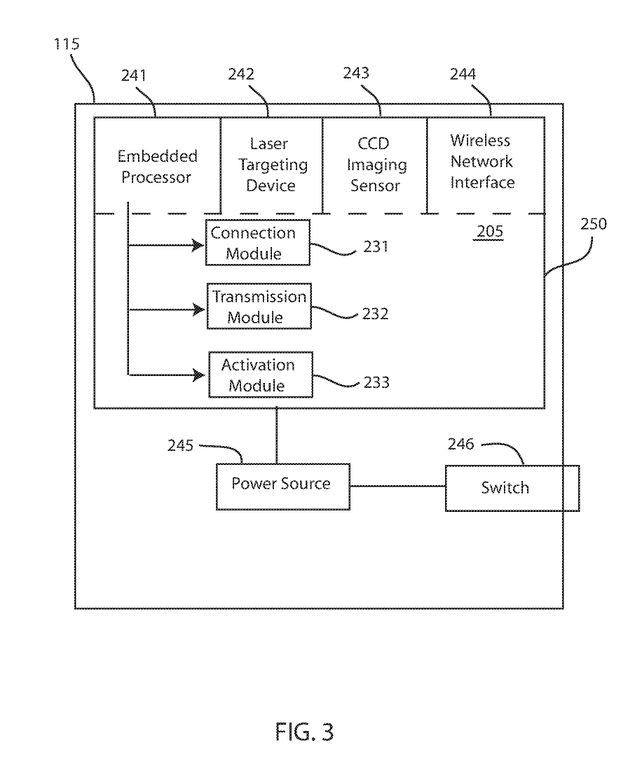

FIG. 3 depicts a block diagram of a portable device 115, in accordance with embodiments of the present invention. Embodiments of the portable device 115 may include hardware and software components. Embodiments of the portable device 115 may include a specialized integrated circuit 250. Embodiments of the specialized integrated circuit may be specialized and dedicated to perform only the methods described herein. Embodiments of the specialized integrated circuit may be an application specific integrated circuit (ASIC). Furthermore, embodiments of the specialized integrated circuit 250 may include an embedded processor, a laser targeting device 242, a charge-coupled device (CCD) imaging sensor 243, and a wireless network interface. Embodiments of the portable device 115 may also include a power source 245, such as one or more batteries. Software components of the portable device 115 may be located in a memory system 205 of the portable device 115, or a memory system coupled to the specialized integrated circuit 250. Embodiments of the specialized integrated circuit 250 of the portable device 115 may include an embedded processor 241 for implementing the tasks associated with the portable device 115. In an exemplary embodiment, the portable device 115 may communicate with the mobile device 111 to transmit information/data needed to facilitate payment for the scanned merchandise. For example, embodiments of the specialized integrated circuit 250 of the portable device 115 may include a wireless network interface 244 for transmitting the information/data contained in the QR code 165 displayed on the display 160 of the POS device 114, over a network, such as a short range communication network. The wireless network interface 244 may also securely and exclusively link the user mobile device 111 associated with a user, over a short range communication network. Embodiments of the specialized integrated circuit 250 of the portable device 115 may be equipped with a CCD imaging sensor 243 or similar imaging sensor to detect, photograph, scan, analyze, or otherwise capture, and process a unique identifier 165 associated with a transaction for scanned merchandise. In an exemplary embodiment, the CCD imaging sensor may be a micro digital camera. Further, embodiments of the specialized integrated circuit 250 of the portable device 115 may include a laser-based targeting device 242. Embodiments of the laser-based targeting device 242 may be a laser source that may illuminate a focused beam of light, which may act as a guide to the user when the user is targeting the portable device 115 at a unique identifier. For instance, the user may point the portable devoice 115 at the POS device display 160 or at a bar code on an item, with the aid of a laser light to guide the pointing of the portable device 115 so that the CCD imaging sensor 243 may capture a unique identifier on the POS device or on the item. In an exemplary embodiment, the laser-based targeting system is a nano-scale laser.

Moreover, embodiments of the portable device 115 may include a switch 246. Embodiments of the switch 246 may be partially located external to a housing of the portable device 115. The switch 246 may be a mechanical switch, or an electromechanical switch. For instance, embodiments of the switch 246 may be a button accessible to the user operating the portable device 115, wherein if the user depresses the switch 246, the power source 245 may be activated (e.g. a circuit is completed by metal-to-metal contact, or other suitable means to employ a switch to turn on a power source may be used). Activating the power source 245 provides power to the specialized integrated circuit 250, and the CCD imaging sensor 243 may be automatically activated as power is provided to the specialized integrated circuit 250. In addition, the laser-based targeting device 242 may be simultaneously activated along with the imaging sensor 243. In an exemplary embodiment, a user may press the switch 246, or a portion of the switch accessible to the user external to the housing, which powers up the specialized integrated circuit to activate the imaging sensor 243 and laser-based targeting device. The user may then visually locate the laser dot projected onto a surface proximate the checkout location, and use the laser to target a unique identifier on a display of a self-checkout computer or a unique identifier located on a product or a product packaging.

Additionally, embodiments of the portable device 115 may include software components, such as a connection module 231, a transmission module 232, and an activation module 233. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory system 205 of the portable device 115 and/or in a memory coupled to the specialized integrated circuit 250. A module (whether hardware, software, or a combination thereof) may be designed to implement or execute one or more particular functions or routines.

Embodiments of the connection module 231 may include one or more components of hardware and/or software program code for establishing a connection or link between the portable device 115 and the mobile device 111, using the wireless network interface 244.

Embodiments of the connection module 231 may exclusively link with the mobile device 111, such that the portable device 115 only communicates with the mobile device 111. The link between the portable device 115 and the mobile device 111 may be established using Bluetooth® technology, near field communication (NFC), and/or a combination thereof In some embodiments, the portable device 115 may include a network interface controller for connecting to the mobile device 111 via the Internet or other communication network. In some embodiments, the portable device 115 may connect to or communicate with the mobile device 111 over the cloud. Moreover, embodiments of the transmission module 232 may include one or more components of hardware and/or software program code for transmitting, sending, or otherwise providing information/digital data retrieved, detected, obtained, captured, or otherwise received from the scanned QR code 165.

Embodiments of the activation module 233 may include one or more components of hardware and/or software program code for deactivating the power source 245. For instance, the power source 245 may be deactivated by embedded processor 241 if the activation module 233 detects that the digital data has been transmitted from the portable device 115. Upon detection that the digital data has been transmitted, the activation module 233 may deactivate the power source 245, which in turn powers down the specialized integrated circuit 250. The power source 245 may be activated again by the actuation of the switch 246.

Embodiments of the portable device 115 for assisting an automatic mobile processing of a transaction, may include a plastic housing having a first end and a second end, a lens being provided at the first end, the housing enclosing: a specialized integrated circuit 250 comprising or consisting of: a charge-coupled device imaging sensor 243 for capturing digital data associated with a unique identifier displayed on a display of a computer located at a checkout location; a wireless network interface 244 for securely and exclusively linking with a user smartphone 111 associated with a user, over a short range communication network; a laser based targeting device 242 for emitting a laser beam outside the plastic housing through the lens; and an embedded processor 241. The portable device 115 may also include a power source 245 for providing a power to the specialized integrated circuit 250, a switch 246 for activating the power source 245, the switch 246 being located at least partially external to the plastic housing, and an attachment mechanism coupled to the second end of the plastic housing, the attachment mechanism being used to attach the portable device to an object.

In exemplary embodiments, the portable device cannot locally perform computations necessary to utilize the digital data to complete the transaction of the portable device 115, or portable imaging device, may lack computational resources to process the digital data from the unique identifier using a mobile payment processing application. The portable device 115 may also lack other applications, sensors and hardware components that other expensive wearable components must include. In one embodiment, the portable device 115 only includes the specialized integrated circuit 250 for performing computer functions. As a result, the portable device 115 requires ultra-low processing requirements for the operation of the portable device 115. The low processing power requirement along with limited hardware components, allows the manufacture of the portable device 115 to be relatively inexpensive. The portable device 115 may be of inexpensive material, such as plastic, for large scale free distribution. In some embodiments, the entire housing of the portable device 115 may be comprised of plastic.

Referring back to FIG. 2, embodiments of the portable device 115 may be used by a user at a checkout location, such as a self-checkout lane or POS device 114, or other location in the retail store where a user intends to scan an item's unique identifier, to effectuate a mobile payment for the scanned merchandise, without having to interact (e.g. physically, verbally, etc.) with the user's mobile device 111. For example, once the user selects a mobile payment option, and the unique identifier, such as QR code 165, is generated and displayed, the user need not grab the user's mobile device 111, but rather manipulate the portable device 115 to scan the QR code 165 when the user is ready to initiate the mobile payment. Manipulating the portable device 115 may include pressing the switch 246 on the housing of the device 115 to power up the imaging sensor 243 of the device 113, and then using the laser emitting from the housing to target the unique identifier. The portable device 115 may then transmit the digital data captured from the QR code to the user's mobile device 111 via the wireless network interface 244, which is linked with the portable device 115. The mobile device 111 may receive the information from the portable device 115, and then communicate with computer system 120 to complete the mobile payment process, as explained in greater detail infra. The specialized integrated circuit 250 may detect that the digital data has been transmitter or otherwise communicated to the user device. In response to the detection of the transmission of the digital data, the specialized integrated circuit 250 may send a deactivation signal to the power source 245 to power down, powering down the specialized integrated circuit 250 and ultimately the portable device 115.

Embodiments of the portable device 115 may include a housing that houses, encloses, supports, encloses, etc. the hardware components of the portable device 115. The housing of the portable device 115 may have various cross-sections. The housing may include a first end and a second end. At one of the first end or the second end, a lens may be inserted to allow light and/or other radiation to pass through. In an exemplary embodiment, the portable device 115 may be a cylindrically shaped device. In other embodiment, the portable device may be shaped similar to a key fob. Furthermore, embodiments of the portable device 115 may be a small, lightweight device. For example, the portable device 115 may have a length of 1-3 inches, and may have a diameter of 0.5-1 inch if cylindrically shaped, or a thickness of an inch or less. The actual dimensions of the portable device 115 may vary such that the portable device 115 may be many shapes and sizes. Embodiments of the portable device 115 may be significantly lighter and dimensionally smaller in size than a mobile device, such as a user cellphone/smartphone. In an exemplary embodiment, the portable device 115 may weigh less than 3 ounces, less than 1 ounce, or less than a 0.5 ounce. The housing of the portable device 115 may be comprised of one or more lightweight materials, such as a plastic. Further, embodiments of the portable device 115 may be inexpensive, especially as compared to an average smartphone. In an exemplary embodiment, the portable device 115 may be inexpensive such that a retailer may distribute the portable device 115 on a large scale, at no cost to the customer. In other embodiments, the portable device 115 may be sold to the customer, or packaged as part of signing up for a promotion or downloading and creating an account for a retailer's mobile software application.

Moreover, embodiments of the portable device 115 may include an attachment mechanism 116. The attachment mechanism 116 may be coupled to the housing of the portable device 115. The attachment mechanism 116 may be coupled to one of the first end or the second end of the housing of the portable device 115. In an exemplary embodiment, the attachment mechanism may be configured to facilitate a connection to a key ring of the user. The attachment device 116 may also facilitate a connection to a clothing of the user, such that the portable device 115 may be a wearable device. In an exemplary embodiment, the attachment device 116 may be a ring, a key ring, a keychain, or a carabiner. The small size and weight of the portable device 115, in addition to the convenience of attachment to a key chain or clothing of the user, may make carrying, holding, manipulating, etc. the portable device 115 easy for a user as the user is checking out at a store.

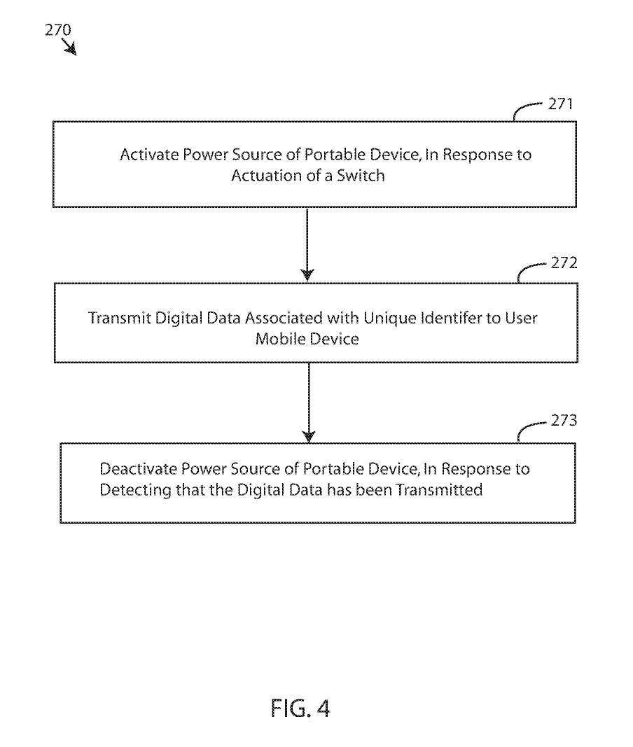

Referring now to FIG. 4, which depicts a flow chart of a method 270 for transmitting data to a user smartphone for processing a transaction at a checkout location, in accordance with embodiments of the present invention. Step 271, in response to an actuation of a switch 246 located at least partially external to a housing of a portable imaging device 115, activates a power source 245 of the portable device 115, the power source 245 providing power to a specialized integrated circuit 250 of the portable imaging device 215, the specialized integrated circuit 250 comprising a charge-coupled device imaging sensor 243 for capturing a unique identifier associated with the transaction that is displayed on a display of a checkout computing device at the checkout location, the unique identifier being generated in response to a payment method selection selected by a user at the checkout computing device to complete the transaction using a mobile payment software application loaded on the user smartphone. Step 272 transmits digital data associated with the unique identifier via a wireless network interface 244 of the specialized integrated circuit 250 of the portable imaging device 215 to the user smartphone 111, and as a function of the transmitting the digital data to the user smartphone 111, the transaction is completed using the mobile payment software application loaded on the user smartphone 111, without user interaction with the user smartphone. Step 273, after detecting that the digital data has been transmitted to the user smartphone, deactivates the power source 245 so that the power source 245 no longer provides power to the specialized integrated circuit 250 of the portable imaging device 115 to reduce a power consumption of the portable imaging device 115.

Referring back to FIG. 1, embodiments of the computing system 120 may include a payment processing module 134. Embodiments of the payment processing module 134 may include one or more components of hardware and/or software program code for automatically processing a payment for the scanned merchandise, in response to a request or communication from the mobile device 111, after the portable device 115 has been used to scan the unique identifier. For instance, embodiments of the payment processing module 134 may receive a request from the user smartphone 111 running a mobile payment software application to complete the transaction, wherein the request from the user smartphone 111 is generated and sent without the user physically interacting with the user smartphone 111. The request may be generated and sent in response to the user smartphone 111 receiving digital data from a portable device 115 that the user physically interacts with to retrieve the transaction details associated with the transaction, the portable device having a specialized integrated circuit 250 that comprises a charge-coupled device 243 for capturing digital data associated with the unique identifier displayed on the display of the checkout computing device, wherein the portable device 115 is securely and wirelessly linked exclusively to the user smartphone 111 via a wireless network interface 244 of the specialized integrated circuit 250 of the portable device 115 to transmit the digital data to the user smartphone, further wherein the user smartphone 111 automatically launches the mobile payment software in response to receiving the digital data from the portable device 115.

The payment processing module 134 may process the request from the mobile device 111 for payment automatically by authenticating the user operating the mobile device 111, obtaining a payment processing information from the mobile device 111, and/or instructing a payment processing application to process a payment for the transaction using the payment processing information received from the mobile device 111. For instance, the payment processing module 134 may authenticate or verify the user operating the mobile device 111. For example, the payment processing module 134 may query one or more databases, such as a customer authentication database 112 to authenticate a user of a mobile device 111. Embodiments of the customer authentication database 112 may be one or more databases, storage devices, repositories, and the like, that may store or otherwise contain information and/or data regarding personal account information of a user, such as name, account identifiers, passwords, pin numbers, address information, other personal identifying information and the like, that may be associated with a mobile application on the mobile device 111 of the user. The customer authentication database 112 may be accessed over network 107, and may be managed and/or controlled by a third party, or by a retailer associated with the mobile application on the user's mobile device 111. Embodiments of the payment processing module 134 may retrieve, receive, obtain, derive, etc. authenticating information from the customer authentication database 112. For instance, the payment processing module 134 may query the customer authentication database 112 to identify a user of the mobile device 111 that transmitted the communication to computer system 120 to process a purchase for merchandise scanned at the POS device 114.

In addition the payment processing module 134 may further use payment account information to authenticate the user of the mobile device 111. For example, the payment processing module 134 may query one or more databases, such as a payment accounts database 110 to further confirm or authenticate the user. Embodiments of the payment accounts database 110 may be one or more databases, storage devices, repositories, and the like, that may store or otherwise contain information and/or data regarding one or more payment instruments associated with the user and the user's mobile application on the mobile device 111. The payment accounts database 110 may also be accessed over network 107, and may be affiliated with, managed, and/or controlled by one or more financial institutions, issuers, authorizers, and the like. Embodiments of the payment processing module 134 may query the payment accounts database 110 to identify a user of the mobile device 111 that transmitted the communication to the computer system 120, based on one or more payment instruments associated with the user. Payment instruments may be a bank account, a credit card account, a debit card, a checking account, an electronic gift card, and the like. Embodiments of the payment processing module 134 may retrieve or otherwise receive payment instrument information stored on the mobile device 111 or stored on a remote server servicing the mobile device 111, and may compare the information to authenticate the user of the mobile device 111.

Referring still to FIG. 1, embodiments of the payment processing module 134 may include one or more components of hardware and/or software program code for receiving payment information and instructing payment for the transaction associated with the scanned merchandise. For example, the payment processing module 134 may receive payment processing information from the mobile device 111. As noted above, the mobile device 111 may transmit user payment account information along with sending the request or communication to the computer system 120 to initiate the payment process. Thus, the payment processing module 134 may receive a communication from the mobile device 111 regarding payment information of the user.

Alternatively, the payment processing module 134 of the computing system 120 may communicate with an application loaded on the user's mobile device 111 to access a local storage of the mobile device 111, which may contain data regarding payment accounts or payment instruments. In another embodiment, the payment processing module 134 may communicate with a remote server or remote storage device that may include data regarding a payment account or payment instrument associated with an application loaded on the customer's mobile device 111. Moreover, embodiments of the payment processing module 134 may also access customer preferences that may be saved on the mobile device 111 or to servers servicing the mobile device's operation of the mobile application to determine a preferred payment method or a preferred payment instrument to be used for purchasing store product. The customer's preferences may also indicate an alternative payment instrument to be used in the event the payment instrument selected as a default expires, or cannot be processed over the network 107 at the time of the purchase.

Embodiments of the payment processing module 134, in response to receiving, obtaining, retrieving, or otherwise determining a payment method, account, instrument, etc. of the user to be used for paying for the scanned product(s), may instruct or direct a payment processing application to process and complete the payment for the scanned product(s). For instance, the payment processing module 134 may transmit, send, direct, or provide instruction to a payment processing application to utilize the user's payment account information to complete the purchase. Embodiments of a payment application may be a mobile application associated with a retailer, a third party application, such as an application managed by a bank or financial institution, or any application that facilitates a transfer of currency from the user's account to the retailer's account, in response to receiving the instruction from the payment processing module 134. Alternatively, the payment processing module 134 may process the payment for the scanned product. In response to receiving the payment instrument information of the user, the payment processing module 134 may transact with a third party application to complete the purchase.

Various tasks and specific functions of the modules of the computing system 120 may be performed by additional modules, or may be combined into other module(s) to reduce the number of modules. Further, embodiments of the computer or computer system 120 may comprise specialized, non-generic hardware and circuitry (i.e., specialized discrete non-generic analog, digital, and logic based circuitry) for (independently or in combination) particularized for executing only methods of the present invention. The specialized discrete non-generic analog, digital, and logic based circuitry may include proprietary specially designed components (e.g., a specialized integrated circuit, such as for example an Application Specific Integrated Circuit (ASIC), designed for only implementing methods of the present invention). Moreover, embodiments of the checkout processing system 100 may improve mobile payment technology by providing a faster and more convenient method of communicating between devices. This may also improve fraud and identity theft technology by verifying the customer who initiates a request to purchase a product from a retailer.

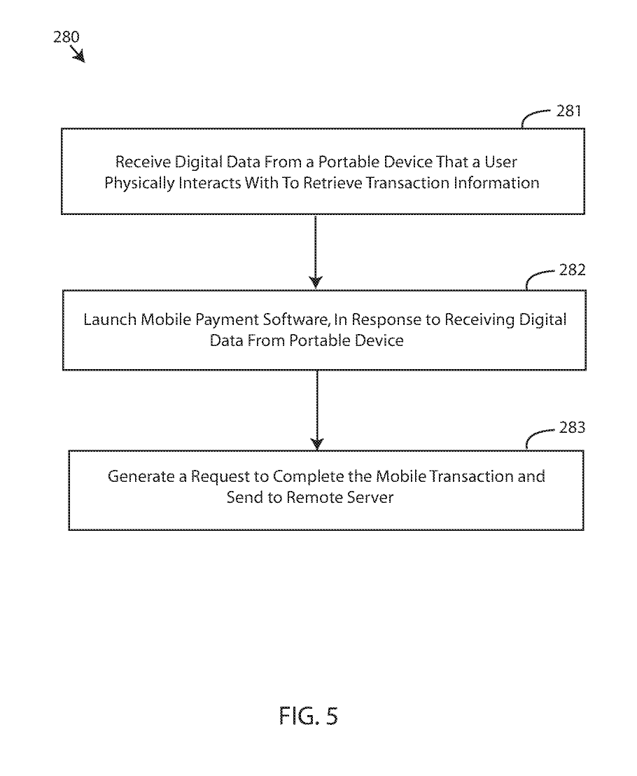

FIG. 5 depicts a flow chart of a method 280 for automatically processing a transaction at a checkout location, in accordance with embodiments of the present invention. Step 281 receives, by a user smartphone, digital data from a portable imaging device that a user physically interacts with to capture a unique identifier, the unique identifier being displayed on a display of a checkout computing device at the checkout location, and generated in response to a payment method selection inputted by the user at the checkout computing device to complete the transaction using a mobile payment software application loaded on the user smartphone, wherein the portable device is securely and wirelessly linked exclusively to the user smartphone to transmit the digital data to the user smartphone. Step 282 launches, by the user smartphone, the mobile payment software application, in response to receiving the digital data from the portable imaging device, without a user interaction with the user smartphone. In particular, the smartphone 111 may detect that digital data has been received pertaining to a transaction, and may automatically launch a mobile payment software application on the smartphone. The application, even after being launched, may operate in the background. Step 283 generates, by the user smartphone 111, a request to complete the transaction, wherein the request from the user smartphone 111 is generated and sent to a remote server (e.g. computing system 120) without the user physically interacting with the user smartphone 111, wherein the remote server is configured to process the request from the user smartphone to complete the transaction.

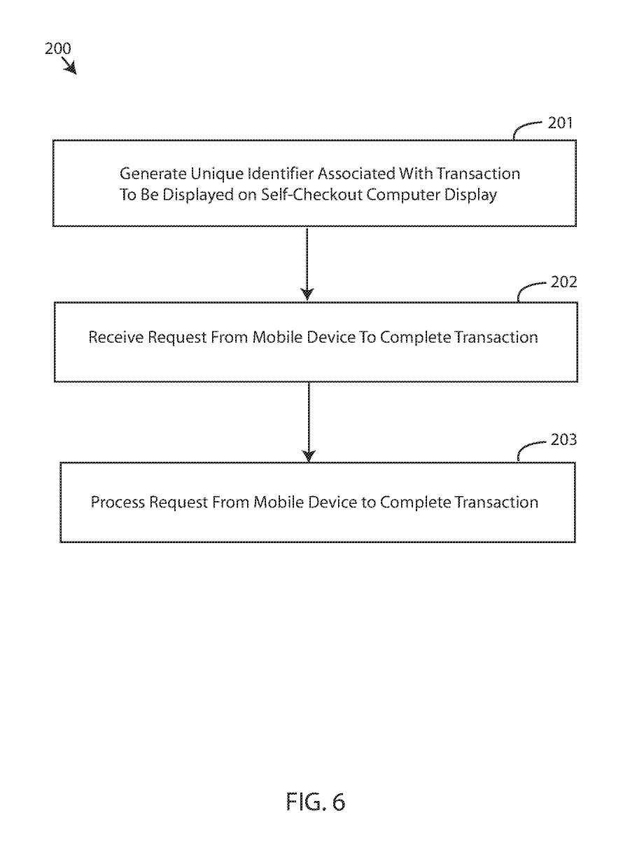

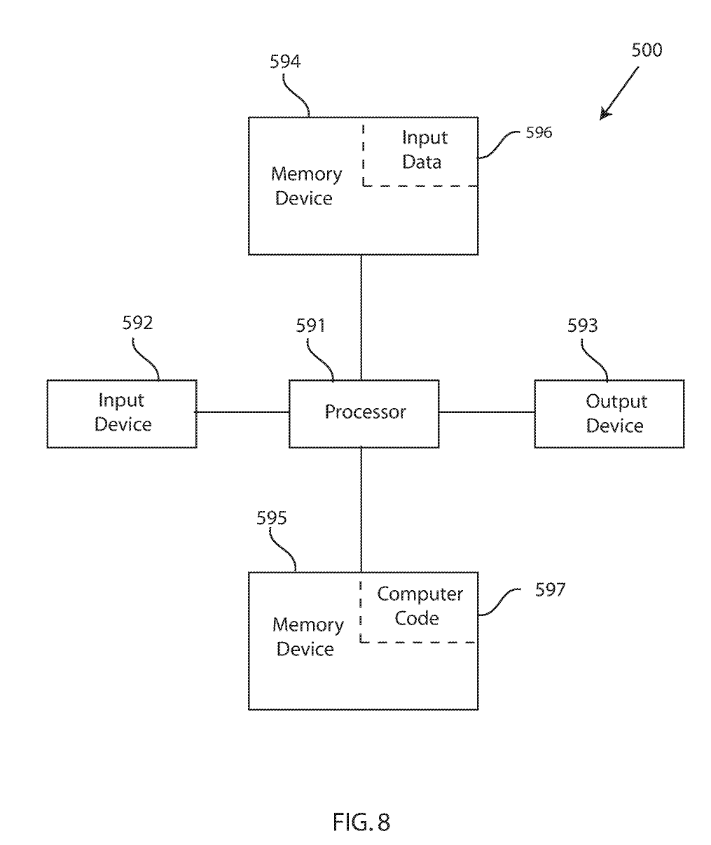

Referring now to FIG. 6, which depicts a flow chart of a method 200 for processing a transaction at a checkout location, in accordance with embodiments of the present invention. One embodiment of a method 200 or algorithm that may be implemented for processing a transaction at a checkout location in accordance with the checkout processing system 100 described in FIGS. 1-3 using one or more computer systems as defined generically in FIG. 8 below, and more specifically by the specific embodiments of FIGS. 1-3.

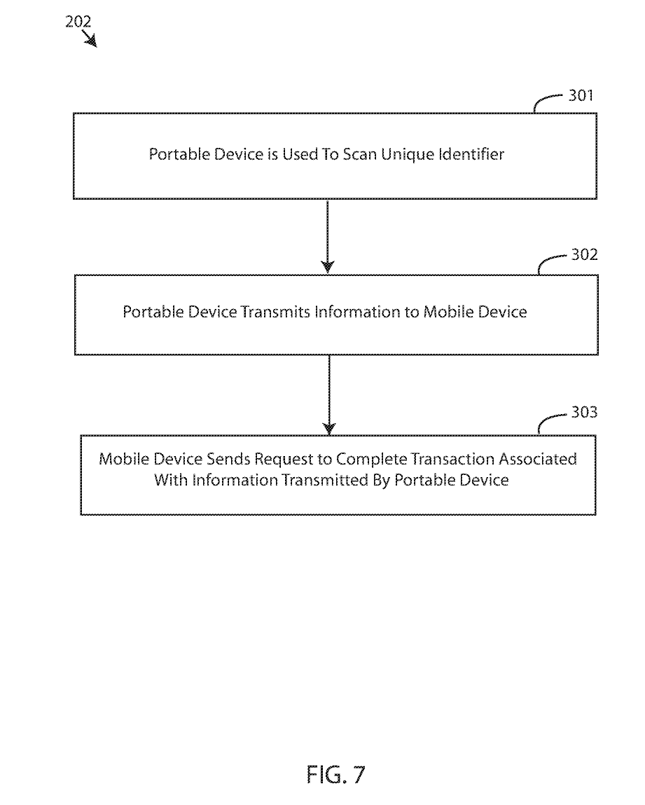

Embodiments of the method 200 for processing a transaction at a checkout location, in accordance with embodiments of the present invention may begin at step 201 wherein a unique identifier associated with a transaction at a POS device 114 is generated. The generated unique identifier may be spawned or otherwise displayed on a display of the POS device 114 at a checkout location. Step 202 receives a communication or request from the mobile device 111 to complete the transaction. For instance, the mobile device 111 may initiate a payment process with computer system 120 to effectuate payment of the scanned merchandise at the POS device 114. FIG. 7 depicts a flow chart of a step 202 in the method 200 for processing a transaction at a self-checkout location of FIG. 6, in accordance with embodiments of the present invention. The communication from the mobile device 111 received in step 202, is sent in response to a user scanning a unique identifier with the portable device 115, as shown in step 301. For instance, a user may manipulate the portable device 115, which includes a camera, to capture the generated and displayed unique identifier. In response to capturing the unique identifier, step 302 transmits the information/data obtained from the unique identifier to the mobile device 111, wherein the portable device 115 and the mobile device 111 are wirelessly linked together. In step 303, the mobile device 111 sends a request or communication to the computer system 120 to complete a transaction associated with the information/data transmitted by the portable device 115. The sending of the request by the mobile device 111 may be done automatically in response to receiving the information/data from the portable device 115.

Referring back to FIG. 6, step 203 processes the request from the mobile device 111 to complete the transaction. The processing step facilitates an automatic, mobile payment for merchandise scanned at a checkout location. The payment processing step may include a verification/authentication step, and may include obtaining payment information to automatically complete the transaction so that the customer is free to leave the store with the purchases merchandise.

The following scenario is described for exemplary purposes to show an embodiment of the implementation of method 200:
A customer has finished shopping, and heads to a self-checkout lane to pay for the items in the customer's shopping cart. The customer uses the product scanner to scan each item at a checkout computer, and bags the items proximate the checkout computer. The customer indicates to the checkout computer that the customer is finished scanning new items, and is ready to pay for the items. The checkout computer prompts the user to indicate which payment method the customer would like to use to purchase the items. The customer selects a mobile payment option.
The checkout computer then goes to a new screen that displays a QR code. Instead of reaching for the customer's cellphone, the customer quickly grabs the customer's keys, which include a portable imaging device linked to the customer's cellphone located in the customer's purse. The customer points the lightweight portable imaging device at the QR code on the screen and scans the QR code.
Once the QR code is scanned by the portable imagine device attached to the customer's keychain, the checkout computer automatically indicates that payment is completed.
   Accordingly, embodiments of method 200 for processing a transaction at a checkout location may be implemented to avoid using a cellphone to effectuate a mobile payment transaction.

FIG. 8 illustrates a block diagram of a computer system 500 that may be included in the system of FIGS. 1-3 and for implementing the methods of FIGS. 4-7 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method f for processing a transaction at a checkout location, in the manner prescribed by the embodiments of FIGS. 4-7 using the checkout processing system of FIG. 1, wherein the instructions of the computer code 597 may be executed by processor 591 via memory device 595. The computer code 597 may include software or program instructions that may implement one or more algorithms for implementing the methods for processing a transaction at a checkout location, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for processing a transaction at a checkout location. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to process a transaction at a checkout location in accordance with embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method f for processing a transaction at a checkout location. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for processing a transaction at a checkout location.

A computer program product of the present invention comprises one or more computer readable hardware storage devices having computer readable program code stored therein, the program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for automatically processing a transaction at a checkout location, the method comprising:
generating, by a processor of a computing system, a unique identifier associated with the transaction to be displayed on a display of a checkout computing device at the checkout location, in response to a payment method selection inputted by a user at the checkout computing device to complete the transaction using a mobile payment software application loaded on a user smartphone;
receiving, by the processor, a request from the user smartphone running the mobile payment software application to complete the transaction, wherein the request from the user smartphone is generated and sent without the user physically interacting with the user smartphone, the request being generated and sent in response to the user smartphone receiving digital data from a portable device that the user physically interacts with to retrieve the transaction details associated with the transaction, the portable device having a specialized integrated circuit that comprises a charge-coupled device for capturing digital data associated with the unique identifier displayed on the display of the checkout computing device, wherein the portable device is securely and wirelessly linked exclusively to the user smartphone via a wireless network interface of the specialized integrated circuit of the portable device to transmit the digital data to the user smartphone, further wherein the user smartphone automatically launches the mobile payment software in response to receiving the digital data from the portable device; and
processing, by the processor, the request from the user smartphone to complete the transaction.
wherein the portable device is used to capture the unique identifier so that the user can avoid interacting with the user smartphone from a beginning of the transaction through an end of the transaction.

2. The method of claim 1, wherein the unique identifier is at least one of a QR code, a bar code, and a UPC code, and a computer readable matrix barcode.

3. The method of claim 1, wherein the processing the request includes:
authenticating, by the processor, the user linked to the mobile payment software application running on the user smartphone;
obtaining, by the processor, a payment processing information from the user smartphone; and
instructing, by the processor, the mobile payment software application to process a payment for the transaction using the payment processing information received from the user smartphone.

4. The method of claim 1, wherein the portable device is securely and wirelessly linked to the user smart phone over a short range communication network.

5. The method of claim 1, wherein the portable devices is a cylindrically shaped device, weighing less than 3 ounces.

6. The method of claim 1, wherein the portable device cannot locally perform computations necessary to utilize the digital data to complete the transaction.

7. The method of claim 1, wherein the portable device is a device attachable to at least one of: a clothing of the user and a key ring of a user, further wherein the portable device is dimensionally smaller and weighs less than the user smartphone.

8. A portable device for assisting an automatic mobile processing of a transaction, the portable device comprising:
a plastic housing having a first end and a second end, a lens being provided at the first end, the housing enclosing:
a specialized integrated circuit comprising:
a charge-coupled device imaging sensor for capturing digital data associated with a unique identifier displayed on a display of a computer located at a checkout location; a wireless network interface for securely and exclusively linking with a user smartphone associated with a user, over a short range communication network;
a laser based targeting device for emitting a laser beam outside the plastic housing through the lens; and
an embedded processor;
a power source for providing a power to the specialized integrated circuit;
a switch for activating the power source, the switch being located at least partially external to the plastic housing;
an attachment mechanism coupled to the second end of the plastic housing, the attachment mechanism being used to attach the portable device to an object;
wherein the portable device cannot locally perform computations necessary to utilize the digital data to complete the transaction.

9. The portable device of claim 8, wherein the charge-coupled device imaging sensor is activated when the switch is actuated by a user.

10. The portable device of claim 9, wherein the laser-based targeting device is simultaneously activated when the charge-coupled device imaging sensor is activated.

11. The portable device of claim 8, wherein the object is at least one of: a clothing of the user and a key ring of a user.

12. The portable device of claim 8, wherein the portable device is dimensionally smaller and weighs less than the user smartphone.

13. The portable device of claim 8, wherein the housing is cylindrically shaped.

14. A method for transmitting data to a user smartphone for processing a transaction at a checkout location, the method comprising:
in response to an actuation of a switch located at least partially external to a housing of a portable imaging device, activating a power source of the portable device, the power source providing power to a specialized integrated circuit of the portable imaging device, the specialized integrated circuit comprising a charge-coupled device imaging sensor for capturing a unique identifier associated with the transaction that is displayed on a display of a checkout computing device at the checkout location, the unique identifier being generated in response to a payment method selection selected by a user at the checkout computing device to complete the transaction using a mobile payment software application loaded on the user smartphone;
transmitting digital data associated with the unique identifier via a wireless network interface of the specialized integrated circuit of the portable imaging device to the user smartphone, and as a function of the transmitting the digital data to the user smartphone, the transaction is completed using the mobile payment software application loaded on the user smartphone, without user interaction with the user smartphone; and
after transmitting the digital data to the user smartphone, deactivating the power source so that the power source no longer provides power to the specialized integrated circuit of the portable imaging device to reduce a power consumption of the portable imaging device.

15. The method of claim 14, further comprising: activating a laser based targeting device of the specialized integrated circuit of the portable imaging device simultaneously with the activation of the charge-coupled device imaging sensor, the laser emitting a laser beam external to the housing of the portable imaging device through a lens of the housing to act as a guide when the portable imaging device is being used to capture the unique identifier.

16. The method of claim 14, wherein the portable imaging device is a cylindrically shaped device, weighing less than 3 ounces.

17. The method of claim 14, wherein the housing is comprised entirely of plastic.

18. The method of claim 14, wherein the portable imaging device is attachable to at least one of: a clothing of the user and a key ring of a user, further wherein the portable imaging device is dimensionally smaller and weighs less than the user smartphone.

19. A method for automatically processing a transaction at a checkout location, the method comprising:
receiving, by a user smartphone, digital data from a portable imaging device that a user physically interacts with to capture a unique identifier, the unique identifier being displayed on a display of a checkout computing device at the checkout location, and generated in response to a payment method selection inputted by the user at the checkout computing device to complete the transaction using a mobile payment software application loaded on the user smartphone, wherein the portable device is securely and wirelessly linked exclusively to the user smartphone to transmit the digital data to the user smartphone;
launching, by the user smartphone, the mobile payment software application, in response to receiving the digital data from the portable imaging device, without a user interaction with the user smartphone; and
generating, by the user smartphone, a request to complete the transaction, wherein the request from the user smartphone is generated and sent to a remote server without the user physically interacting with the user smartphone, wherein the remote server is configured to process the request from the user smartphone to complete the transaction.
